(19) United States
(12) Patent Application Publication
(10) Pub. No.: US 2016/0356925 A1
(43) Pub. Date: Dec. 8, 2016

(54) OPTICAL ELEMENT WITH SAPPHIRE LAYER

(71) Applicant: Vertu Corporation Limited

(72) Inventor: Fiona Lowrie, Farnborough (GB)

(21) Appl. No.: 15/101,265

(22) PCT Filed: Dec. 3, 2013
(86) PCT No.: PCT/EP2013/075352

§ 371 Date: Jun. 2, 2016

(51) Int. Cl. G02B 1/118; G02B 1/12; G02B 1/14; G02B 1/02; G02B 1/113

(52) U.S. Cl. CPC G02B 1/118; G02B 1/02; G02B 1/113; G02B 1/14; G02B 1/12

(57) ABSTRACT

An optical element for a mobile apparatus comprising a layer of sapphire having a first refractive index value and comprising a surface, wherein the surface is visible to a user. The optical element further comprises a textured structure arranged on the surface of the layer of sapphire for affecting propagation of visible light incident upon the surface of the layer of sapphire, wherein the structure is configured to have a second refractive index value, the second refractive index value being lower than the first refractive index value, and wherein the textured structure is configured to reduce reflection of the visible light incident from the surface of the layer of sapphire.

### TECHNICAL FIELD

The present invention relates generally to optical elements. The invention relates particularly, though not exclusively, to using a sapphire layer in the optical element of a mobile apparatus.

### BACKGROUND ART

Portable apparatuses, such as mobile phones, tablets and personal computers all need optical elements, such as transparent plastics and glass when constructing the product. With increasing consumer awareness of quality and value mobile manufacturers are continuing to use more and more quality materials. With respect to mobile phones and tablets, the last couple of years have seen a market shift from use of plastic screens to more scratch resistant chemical toughened glass (for example Gorilla® Glass).

While Gorilla® Glass is a significant improvement over plastic it can still be scratched by everyday items such as keys or coins in bags and pockets. Also, the glass is easily fractured if the product is dropped. For this reason sapphire, for example, is being considered more and more for use on consumer goods. Sapphire is the second hardest naturally occurring material and can only be scratched by a small number of harder materials, such as diamonds. Sapphire is also a strong material and has a very high elastic modulus (stiffness). Thus, using sapphire in the construction of mobile apparatuses creates a very stiff product that is less likely to flex during accidental drop or impact. This makes sapphire a very resistant, long lasting material for mobile apparatus usage.

Typically, mobile phones, tablets, MP3 players and personal computers comprise optical element (such as display) materials that provide a protective cover to the actual optical element. Such protective cover may be plastic, glass, or sapphire, for example.

Sapphire is used as a protective cover material due to its higher hardness and strength compared to both plastic and glass, which prevents the screen being scratched or broken during daily use.

Optical elements utilize propagation of light. An important factor of all optical elements, especially display screens, is that the display can be viewed by the user of the apparatus, as good as possible. Viewing occurs through light from the display reaching the viewer's eye. However, light from the surroundings (incident light) may also fall onto the display, and some of this incident light is reflected from the display screen surface. The extent of reflected light at the surface of the display screen compared to transmitted light depends on the refractive index, n, of the screen material. More reflection occurs at the surface of materials with a higher value for n. Sapphire has a higher n value than, e.g. glass or plastic, and the amount of light that will be reflected from a single sapphire surface in air may be ˜8%. In bright conditions, such as a sunny day, when there is a significant amount of incident light falling on the surface of the screen, the amount of reflected light can be greater than the light from the display itself and hence cause considerable difficulty for the user in viewing the display.

Thus, especially for portable apparatuses an improved solution is needed to provide an optical element made of sapphire that reduces reflection of incident light and improves the visibility of the optical element by the user.

### SUMMARY

According to a first example aspect of the invention there is provided an optical element for a mobile apparatus comprising:
a layer of sapphire having a first refractive index value and comprising a surface, wherein the surface is visible to a user; and
a textured structure arranged on the surface of the layer of sapphire for affecting propagation of visible light incident upon the surface of the layer of sapphire, wherein the structure is configured to have a second refractive index value, the second refractive index value being lower than the first refractive index value, and wherein the textured structure is configured to reduce reflection of the visible light incident from the surface of the layer of sapphire.

In an embodiment, the textured structure is configured to make the surface of the layer of sapphire uneven.

In an embodiment, the textured structure comprises curved shapes.

In an embodiment, the textured structure comprises sinusoidal shapes.

In an embodiment, the textured structure has dimensions of order of 100-400 nm.

In an embodiment, the textured structure is integral to the layer of sapphire.

In an embodiment, the textured structure is arranged as a coating to the layer of sapphire.

In an embodiment, the coating is a sapphire coating.

In an embodiment, the coating is an alumina coating.

In an embodiment, the coating is a physical vapor deposition (PVD) coating of at least one of the following: Titanium nitride, Zirconium nitride, Chromium nitride, and Titanium aluminum nitride.

In an embodiment, the coating is a chemical vapor deposition (CVD) coating of at least one of the following: Silicon based compounds such as Silicon dioxide.

In an embodiment, the optical element further comprises at least one of the following:
a display of the mobile apparatus;
a cover part of the mobile apparatus; and
a touch sensitive screen of the mobile apparatus.

In an embodiment, the element has a length in a direction of a first axis and a width in a direction of a second axis, wherein the length is greater than or equal to the width, the optical element further comprising:
sapphire crystallographic structure having a plurality of crystal planes, wherein a first crystal plane axis is configured to be perpendicular to the first and the second axis, a second crystal plane axis is configured to be parallel to the first axis and a third crystal plane axis is configured to be parallel to the second axis.

In an embodiment, the plurality of crystal planes comprising:
A-plane with A-axis configured to be a normal axis of the A-plane;
C-plane with C-axis configured to be a normal axis of the C-plane, the C-axis being perpendicular to the A-axis; and
M-plane with M-axis configured to be a normal axis of the M-plane, the M-axis being perpendicular to the A-axis and the C-axis.

In an embodiment, the first crystal plane axis is the A-axis, the second crystal plane axis is the M-axis and the third crystal plane axis is the C-axis.

In an embodiment, a fourth crystal plane axis is configured to be perpendicular to the first crystal plane axis and inclined to the second and the third crystal plane axes.

In an embodiment, the optical element having a length in a direction of the M-axis and a width in a direction of the C-axis, wherein the length is greater than or equal to the width.

In an embodiment, the optical element is transparent.

According to a second example aspect of the invention there is provided a method comprising:
providing a layer of sapphire having a first refractive index value and comprising a surface; and
providing a textured structure on the surface of the layer of sapphire for affecting propagation of visible light incident upon the surface of the layer of sapphire, wherein the structure is configured to have a second refractive index value, the second refractive index value being lower than the first refractive index value, and wherein the textured structure is configured to reduce reflection of the visible light incident from the surface of the layer of sapphire.

In an embodiment, the method further comprises:
providing the textured structure on the surface of the layer of sapphire using at least one of the following techniques:
   lasering the surface of the layer of the sapphire;
   ion bombardment of the layer of the sapphire;
   chemical etching; and
   plasma etching.

In an embodiment, the method further comprises:
applying a textured surface coating to the surface of the layer of sapphire using chemical vapor deposition (CVD) or physical vapor deposition (PVD).

In an embodiment, the method further comprises:
attaching the textured surface coating to the surface of the layer of sapphire using an adhesive.

In an embodiment, the method further comprises:
polishing the surface of the layer of sapphire before applying the textured surface coating to the surface of the layer of sapphire.

According to a third example aspect of the invention there is provided a mobile apparatus comprising an optical element of the first aspect.

In an embodiment, a higher strength axis of a sapphire element is aligned with a higher stress direction of the mobile apparatus.

The mobile apparatus may comprise a portable apparatus, such as a tablet, a smartphone, a mobile phone, a laptop, a digital camera or a personal digital assistant (PDA), for example.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The invention will be described, by way of example only, with reference to the accompanying drawings, in which:

FIG. 1 shows some details of a mobile apparatus in which various embodiments of the invention may be applied;

FIG. 2 shows some details of a mobile apparatus in which various embodiments of the invention may be applied;

FIG. 3 shows an illustrative example on incident light reflection and transmission arrangement in which various embodiments of the invention may be applied;

FIG. 4 presents a schematic view of a sapphire crystallographic structure 410 for an optical element, in which various embodiments of the invention may be applied;

FIG. 5 presents a schematic view of an optical element, in which various embodiments of the invention may be applied;

FIG. 6 shows a flow diagram showing operations, in accordance with an example embodiment of the invention;

FIG. 7 presents an example block diagram of an apparatus in which various embodiments of the invention may be applied;

FIG. 8 shows a schematic view of an optical element with a textured structure as an integral part of a sapphire layer without reducing the strength of the sapphire layer below a threshold, in which various embodiments of the invention may be applied;

FIG. 9 shows a schematic view of an optical element with a textured structure applied on a sapphire layer as a coating without reducing the strength of the sapphire layer below a threshold, in which various embodiments of the invention may be applied; and

FIG. 10 shows a schematic view of a sapphire crystal structure, known also as a unit cell, having a plurality of crystal planes, in which various embodiments of the invention may be applied.

### DETAILED DESCRIPTION

In the following description, like numbers denote like elements.

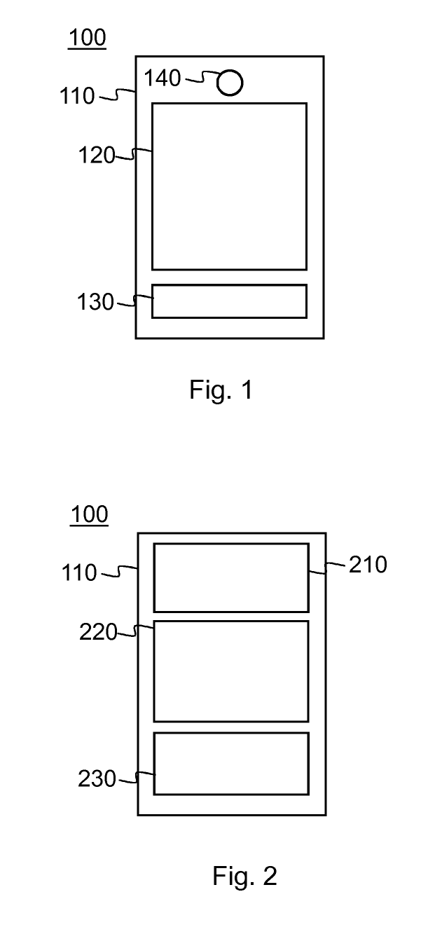

FIG. 1 shows some details of a mobile apparatus 100 in which various embodiments of the invention may be applied.

In an embodiment, the mobile apparatus 100 may comprise a mobile phone, a smart phone, a tablet, a laptop or any other portable apparatus. The apparatus comprises at least one cover part 110 for providing protection to the components of the apparatus 100 and creating desired outlook and outer design for the apparatus 100. The cover part 110 may comprise several separate cover parts, such as front and rear covers and even a side frame. In FIG. 1, mainly the front cover is shown. The apparatus 100 further comprises user interface 120, 130 comprising at least one display 120. The display 120 may be a touch-sensitive display for detecting user gestures and providing feedback for the apparatus 100. The apparatus 100 may also comprise a user input device 130, such as a keypad or a touchpad, for example. Furthermore, the apparatus 100 may comprise a camera 140. No matter the described elements 110, 120, 130, 140 are shown on the same side of the apparatus 100, they can be located on any side of the apparatus 100. No matter a plurality of apparatus elements 120-140 are illustrated in FIG. 1, they all need not to be included. For example, only a touch-sensitive display 120 may be included without the need for separate user input device 130.

In an embodiment, at least one of the apparatus elements 110, 120, 130, 140 comprises an optical element, such as transparent sheet, layer or glass, for example. The cover part 110 may comprise an optical element, such as transparent layer coating, to provide good-looking, strong and scratch resistant surface for the apparatus. The display 120 may comprise an optical element, such as a transparent protection layer, to provide strong and scratch-resistant surface for the display but still enable clear visibility for the display 120 from all angles. The user input device may comprise an optical element, similarly as the display, in case of a touchpad, and similarly as the cover part for the keypad frame in case of a traditional keypad. The camera 140 may comprise an optical element, such as protective lens, for example.

In an embodiment, the display 120 may form a permanent part of the cover part 110 or, to increase the potential for upgrading the engine throughout the life of the cover part 110 it may be a module that can be replaced too. Alternatively, a protective layer of the display 120 may be a part of the cover part 110 that layer may be independently exchanged. In further alternative embodiment the protective layer of the display 120 is integrated to the cover part 110.

The cover part 110 may comprise a casing for a mobile apparatus for receiving an engine for operation of the device, the casing comprising: a surface layer as an optical element, mounted on a defined area of a housing defining, along with the surface layer, an exterior of the housing; and means for engaging the exposed areas of the substrate with the housing. The surface layer can conveniently be adhered to the substrate. The adherent may be a UV curing adhesive, for example.

In embodiments of the invention the surface layer may provide an operating face of the device. This gives a design engineer far greater freedom to design a device with a desirable appearance. The operating face may be provided with a user input element 130, for example a key, a touchpad, or an array of such elements. The casing may be a conventional one part casing or a clam shell, or other two or more part arrangement, where the user input elements 130 or keys may be located on a different face to a display 120.

FIG. 2 shows some details of a mobile apparatus 100 in which various embodiments of the invention may be applied.

In an embodiment, the cover part 110 may also comprise a plurality of cover part elements, located in front and rear covers and in a side frame. In FIG. 2, mainly the rear cover of the apparatus 100 is shown. The apparatus 100 may comprise cover part elements comprising optical elements 210-230. Such optical elements 210-230 may be configured to provide decorative effects, protective features for underlying elements, or operational features for the apparatus 100, such as speaker or microphone housings. The rear cover of the cover part 110 shown in FIG. 2 may also comprise optical elements 210-230, such as display or touchpad, for example. No matter the described elements 210-230 are shown on the same side of the apparatus 100, they can be located on any side of the apparatus 100. No matter a plurality of apparatus elements 210-230 are illustrated in FIG. 2, they all need not to be included.

In an embodiment, at least one of the apparatus elements 210-230 comprises an optical element, such as transparent sheet, layer or glass, for example. The cover part 110 may comprise an optical element, such as transparent layer coating, to provide good-looking, strong and scratch resistant surface for the apparatus.

Sapphire may be used for mobile apparatus optical elements, such as display, cover part element or touch pad, for example. Sapphire has high hardness and strength but its higher refractive index means that more light is reflected from the surface compared to prior known glass or plastic screens. On bright days the reflectance from the surface may cause the display to appear ‘washed out’ or difficult to be viewed.

A way of reducing the amount of reflection from the surface of the sapphire screen is required that will not degrade the hardness, strength or the other optical properties of the sapphire.

The present invention discusses both sapphire and alumina. The chemical composition of both is based on Al₂O₃. For clarifying purposes, sapphire may be understood in this context as a single crystal of alumina and alumina as a polycrystalline form of alumina (PCA).

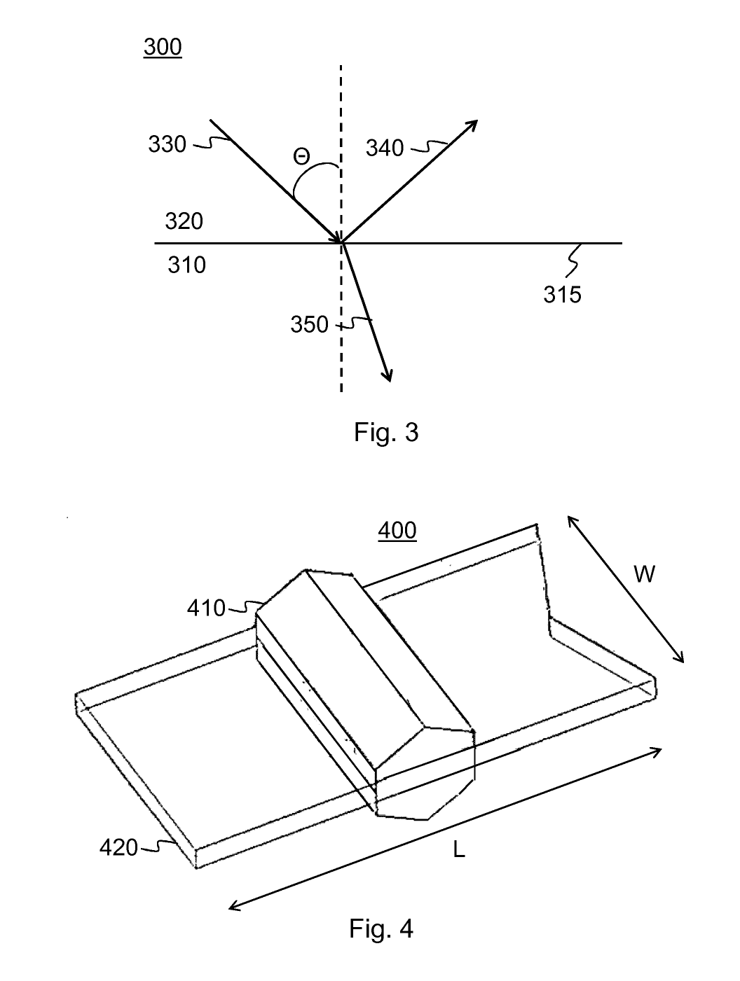

FIG. 3 shows an illustrative example on incident light reflection and transmission arrangement 300 in which various embodiments of the invention may be applied.

In an embodiment, light 330 is travelling through air 320 and is incident upon the surface 315 of an optical element 310. The optical element 310 may comprise sapphire and a fraction of the light 330 will be reflected as reflected light 340 and a fraction will be transmitted as transmitted light 350 into the optical element 310. The values of the reflected light and the transmitted light depend on a variety of factors. The most notable factors include the angle of incidence (θ) and the index of refraction of air and the index of refraction of the material that the light is approaching, in this case the sapphire. The index of refraction of air is approximately 1. The index of refraction value of sapphire is much higher than that of glass and this causes increased reflections of incident light when using sapphire, compared to the prior art solutions of glass. Furthermore, the sizes of optical elements, such as displays, increase all the time in portable apparatuses thus making the reflection problem even bigger.

In an embodiment, a structure is arranged on a surface of a layer of sapphire in an optical element of a mobile apparatus. The purpose of the structure is to reduce the reflection of visible light from the sapphire surface. However, the hardness and strength of the sapphire must not be compromised, because this would make the sapphire unsuitable for use as a screen for mobile apparatuses. This means the structure design and processing method must be optimized so that the strength of the sapphire is not degraded.

Sapphire is a single crystal material, i.e. it is grown as a continuous large single crystal without grain boundaries. Such a single crystal may be grown before cutting to a desired size and shape for an optical element.

The sapphire single crystal, i.e., Al₂O₃, is used because it has higher hardness and toughness than e.g. glass. The single crystal of sapphire may be pulled, growing a seed crystal in contact with the surface of the molten alumina to produce the single crystal into a larger single crystal, so as to generally work the single crystal into the desired shape.

FIG. 4 presents a schematic view 400 of a sapphire crystallographic structure 410 for an optical element 420, in which various embodiments of the invention may be applied.

The optical element 420 may be a display element, for example. The optical element 420 is developed by growing the sapphire crystallographic structure 410. The growing may be arranged in desired planes after detecting the planes and axes of the sapphire single crystal, for example.

In an embodiment, the desired dimensions of the optical element 420 comprise a length L over a first axis and a width W over a second axis, as shown in FIG. 4.

In an embodiment, orientation of the sapphire unit cell 410 may be selected so that the plane of the optical element 420 corresponds to certain planes of the sapphire cell.

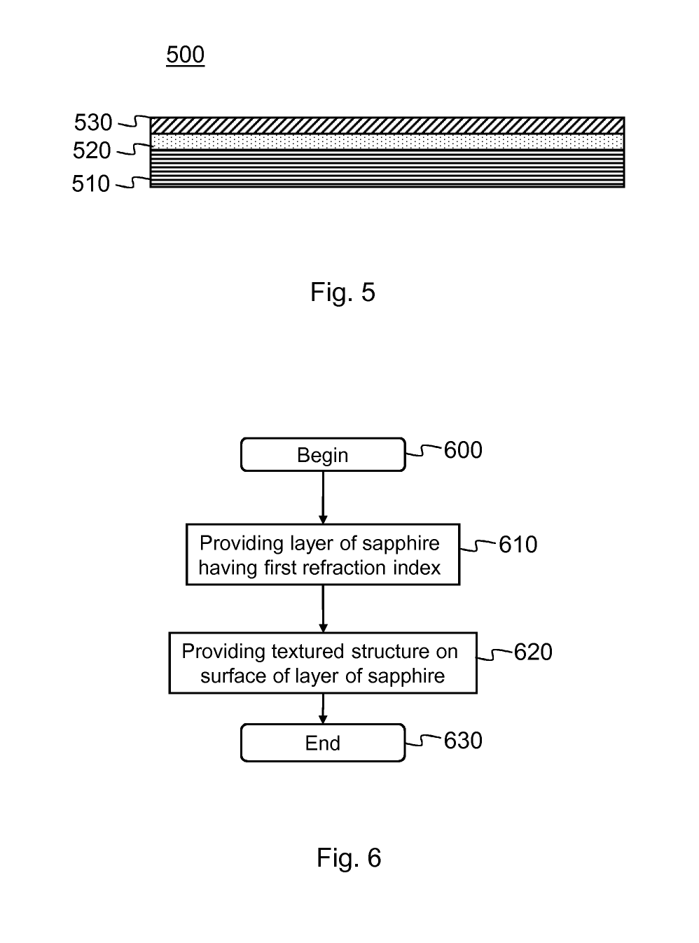

FIG. 5 presents a schematic view of an optical element 500, in which various embodiments of the invention may be applied. The optical element 500 may comprise a layer of sapphire 520 having a first refractive index value and comprising a surface, wherein the surface is visible to a user.

In an embodiment, reflections may be reduced using a textured structure 530. The textured features may reduce the reflection by either ‘trapping’ incident light within the structure 530 and or by creating a gradual change in the overall structure's refractive index n. The structure can be applied to the screen as a surface coating or film or be an inherent part of the display screen. A textured structure 530 created as part of the sapphire screen surface 520 may be a permanent and robust solution for reducing the reflectance from a sapphire mobile apparatus screen.

In an embodiment, a textured structure 530 is arranged on the surface of the layer of sapphire 520 for affecting propagation of visible light incident upon the surface of the layer of sapphire. The structure 530 is configured to have a second refractive index value, the second refractive index value being lower than the first refractive index value. Furthermore, the textured structure 530 is configured to reduce reflection of the visible light incident from the surface of the layer of sapphire.

In an embodiment, the optical element 500 may comprise an element 510 below the layer of sapphire 520. Such element may comprise, for example, a display element or decorative element.

In an embodiment, the layer of sapphire 520 is an integral part of the element 510, such as cover layer 520 of the display 510.

In an embodiment, the textured structure 530 is an integral part of the sapphire layer 520.

In an embodiment, the textured structure 530, the sapphire layer 520 and the optical element 510 are integrated together.

In an embodiment, the textured structure 530 comprises an alumina coating or a sapphire coating.

In an embodiment, the textured structure 530 is attached to the surface of the sapphire layer 520 using an adhesive.

In an embodiment, the textured structure 530 is attached to the surface of the sapphire layer 520 using chemical vapor deposition (CVD). The attached structure 530 may comprise a coating layer that is a chemical vapor deposition (CVD) coating of at least one of the following: Silicon based compounds such as Silicon dioxide.

In an embodiment, the textured structure 530 is attached to the surface of the sapphire layer 520 using physical vapor deposition (PVD). The attached structure 530 may comprise a coating layer that is a physical vapor deposition (PVD) coating of at least one of the following: Titanium nitride, Zirconium nitride, Chromium nitride, and Titanium aluminum nitride.

In an embodiment, the coating layer 530 may be made of hard oxides, nitrides or carbides, for example, such as alumina and silicon nitride. Silica may also be an option, although it is not as hard as these other mentioned materials. These materials may all be deposited by PVD and CVD methods, for example.

When selecting a material for a coating layer 530, refractive index values of the materials need to be checked. A material and method of application for the coating layer 530 should be selected based on the refractive index so that no further interface between the coating layer 530 and the sapphire layer 520 is created that would cause disturbing reflections.

Also, if using adhesive for attaching the textured structure 530, such as a coating or film layer, to the sapphire layer 520, a careful selection of the adhesive may be needed. An adhesive is selected to be optically optimized to ensure the adhesive does not create any disturbing reflections.

There are several different processing methods within the overall PVD and CVD routes for providing the textured structure 530. For example, methods such as plasma enhanced (plasma assisted), arc and electron beam could be used for PVD and/or CVD. Furthermore, a method of Glancing Angle Deposition (GLAD) PVD could also be used. Such method entails rotating a sample so that various sections are shielded during the coating process, leading to build up of a coating in front of the shielded areas but not behind them. Such method could be used to create the textured structure 530 on top of the sapphire layer 520.

In an embodiment, PVD and CVD processes may apply a coating layer 530 that follows the surface profile of the substrate layer 520, such as sapphire layer. In this case the sapphire substrate layer 520 may be smooth and flat and so the coating layers 530 are likely to be so too. In such case the coating layer 530 may be applied in a specific way to ensure a textured profile for the coating layer 530 to be achieved. For example, Glancing Angle Deposition (GLAD) may be used to provide the textured structure for the coating layer 530.

In an embodiment, the textured structure 530 is modified so that the dimensions of the structure 530 are configured also to reflect longer wavelengths, such as within the infra-red region. By doing this the optical element 500 may be improved by preventing the element 500 from getting too hot if left out in the sunshine for example.

In an embodiment, the structure 530 is an inherent part of the sapphire surface 520. This requires sapphire material to be removed from the surface in such a way that the required features made of sapphire are left exposed. Sapphire is a hard and inert material and so removal of material needs careful processing. This could be done by techniques such as laser or ion bombardment but the preferred technique would be through chemical or plasma etching because these methods are less likely to degrade the sapphire's mechanical properties.

The strength of the sapphire screen 530 could be degraded through the introduction of stress concentration points or cracks on a nano-scale and so the shape of the features must be designed to minimize this. In particular, sharp angles between the bases of the features should be avoided.

In an embodiment, a textured surface 530 may be applied as a coating to the sapphire surface 520. Depending on the coating material, the film 530 would need to be extremely thin (of the order of less than a micron) to maintain transparency and would also need to be of a very hard material, so that it would not be scratched or damaged by daily use. For example alumina could be used as the coating 530. Coating application methods include chemical vapor deposition (CVD) and physical vapor deposition (PVD), for example. The coating 530 would need to be deposited so that it was built up into the texture structure dimensions. For reducing reflection of visible light the structure dimensions may be of the order of 100-400 nm, for example, but depending on the embodiment and implementation the structure dimensions may be of a different order.

The solution for reducing reflection from a traditional screen of a mobile apparatus requires the use of anti-reflective coatings, which operate on the interference principle. These coatings are damaged over time by daily use.

The present invention allows a durable anti-reflection surface 530 to be produced on sapphire screens 520 without degrading the required strength of the sapphire layer and so improve significantly the visibility of mobile apparatuses and other electronic devices with sapphire surfaces.

Applying an alumina coating 530 would not introduce stress concentration points into the sapphire screen 520 but the adhesion of the coating to the sapphire screen would be critical.

The coating method could be used after the final polishing step in the polishing process of the sapphire screen surface, in order to ensure the sapphire was of maximum strength.

In an embodiment, a further layer (not shown) on top of the textured structure 530 may be applied. Such layer is configured to provide easy-clean or anti-smudge surface for the textured structure 530, for example. Thus the optical element 500 may be further improved in terms of reduced reflection and being easier to clean.

FIG. 6 shows operations in a portable apparatus in accordance with an example embodiment of the invention.

In step 600, a method for providing an optical element is stated. In step 610, a layer of sapphire having a first refractive index value and comprising a surface is provided. In step 620, a textured structure is provided on the surface of the layer of sapphire for affecting propagation of visible light incident upon the surface of the layer of sapphire, wherein the structure is configured to have a second refractive index value, the second refractive index value being lower than the first refractive index value, and wherein the textured structure is configured to reduce reflection of the visible light incident from the surface of the layer of sapphire.

The textured structure may be provided on the surface of the layer of sapphire using at least one of the following techniques:
lasering the surface of the layer of the sapphire;
ion bombardment of the layer of the sapphire;
chemical etching; and
plasma etching.

A textured surface coating may be applied to the surface of the layer of sapphire using chemical vapor deposition (CVD).

Certain physical vapor deposition (PVD) processes could also apply an alumina coating, although the product might not be as robust as the chemical vapor deposition (CVD) method.

The textured surface coating may be attached to the surface of the layer of sapphire using an adhesive.

In an embodiment, the surface of the layer of sapphire is polished before applying the textured surface coating to the surface of the layer of sapphire.

In step 630, the method ends.

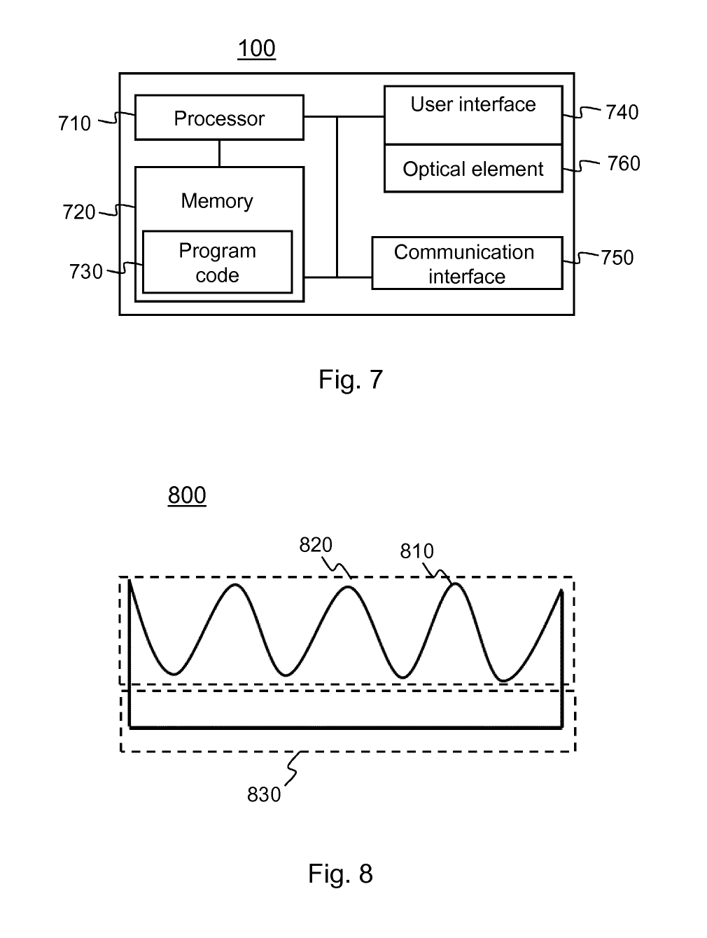

FIG. 7 presents an example block diagram of a portable apparatus 100 in which various embodiments of the invention may be applied. The portable apparatus 100 may be a user equipment (UE), user device or apparatus, such as a mobile terminal, a smart phone, a personal digital assistant (PDA), a MP3 player, a laptop, a tablet or other electronic device.

The general structure of the mobile apparatus 100 comprises a user interface 740, a communication interface 750, a processor 710, and a memory 720 coupled to the processor 710. The apparatus 100 further comprises software 730 stored in the memory 720 and operable to be loaded into and executed in the processor 710. The software 730 may comprise one or more software modules and can be in the form of a computer program product. The apparatus 100 further comprises an optical element 760 comprising a layer of sapphire having a first refractive index value and comprising a surface, wherein the surface is visible to a user. The optical element 760 further comprises a textured structure arranged on the surface of the layer of sapphire for affecting propagation of visible light incident upon the surface of the layer of sapphire, wherein the structure is configured to have a second refractive index value, the second refractive index value being lower than the first refractive index value, and wherein the textured structure is configured to reduce reflection of the visible light incident from the surface of the layer of sapphire. The reduced reflection is applied so that the strength of the sapphire layer is still maintained to an adequate level. The optical element 760 may also be integrated to another element of the apparatus 100, for example to the user interface 740.

The processor 710 may be, e.g. a central processing unit (CPU), a microprocessor, a digital signal processor (DSP), a graphics processing unit, or the like. FIG. 7 shows one processor 710, but the apparatus 100 may comprise a plurality of processors.

The memory 720 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 100 may comprise a plurality of memories. The memory 720 may be constructed as a part of the apparatus 100 or it may be inserted into a slot, port, or the like of the apparatus 100 by a user. The memory 720 may serve the sole purpose of storing data, or it may be constructed as a part of an apparatus serving other purposes, such as processing data.

The user interface 740 may comprise circuitry for receiving input from a user of the apparatus 100, e.g., via a keyboard, graphical user interface shown on the display of the user apparatus 100, speech recognition circuitry, or an accessory device, such as a headset, and for providing output to the user via, e.g., a graphical user interface or a loudspeaker. The display of the user interface 740 may comprise a touch-sensitive display. The optical element 760 may be integrated to the user interface 740, such as a display, a keyboard, or a touchpad. The optical element may also be integrated to a cover part of the apparatus 100.

The optical element 760 may also be comprised by the camera, for providing a protective sheet for the camera optics. The optical element 760 may also provide a protective sheet for multiple elements of the apparatus 100. In an example embodiment, an optical element 760 is configured to provide a protective sheet for the display of the apparatus 100. The optical element may even cover at least a part of the front, rear or side surface of the apparatus 100 cover.

The communication interface module 750 implements at least part of radio transmission. The communication interface module 750 may comprise, e.g., a wireless interface module. The wireless interface may comprise such as near field communication (NFC), a WLAN, Bluetooth, infrared (IR), radio frequency identification (RF ID), GSM/GPRS, CDMA, WCDMA, or LTE (Long Term Evolution) radio module. The communication interface module 750 may be integrated into the user apparatus 100, or into an adapter, card or the like that may be inserted into a suitable slot or port of the apparatus 100. The communication interface module 750 may support one radio interface technology or a plurality of technologies. The apparatus 100 may comprise a plurality of communication interface modules 750.

A skilled person appreciates that in addition to the elements shown in FIG. 7, the apparatus 100 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the apparatus 100 may comprise a disposable or rechargeable battery (not shown) for powering when external power if external power supply is not available.

FIG. 8 shows a schematic view of an optical element 800 with a textured structure 820 on a sapphire layer 830 without reducing the strength of the sapphire layer below a threshold, in which various embodiments of the invention may be applied.

In an embodiment, sharp angles are avoided in the textured structure 820 due to they are potential areas of stress concentration and sources of damage to the rest of the sapphire screen. FIG. 8 shows an example schematic of the design required. A sinusoidal profile 810 with smooth sides, rounded tips and gentle curves between the peaks may be used. There are no corners or sharp angles at the base or top of the peaks. The textured structure 820 is made as inherent part of sapphire layer 830 to provide the optical element 800.

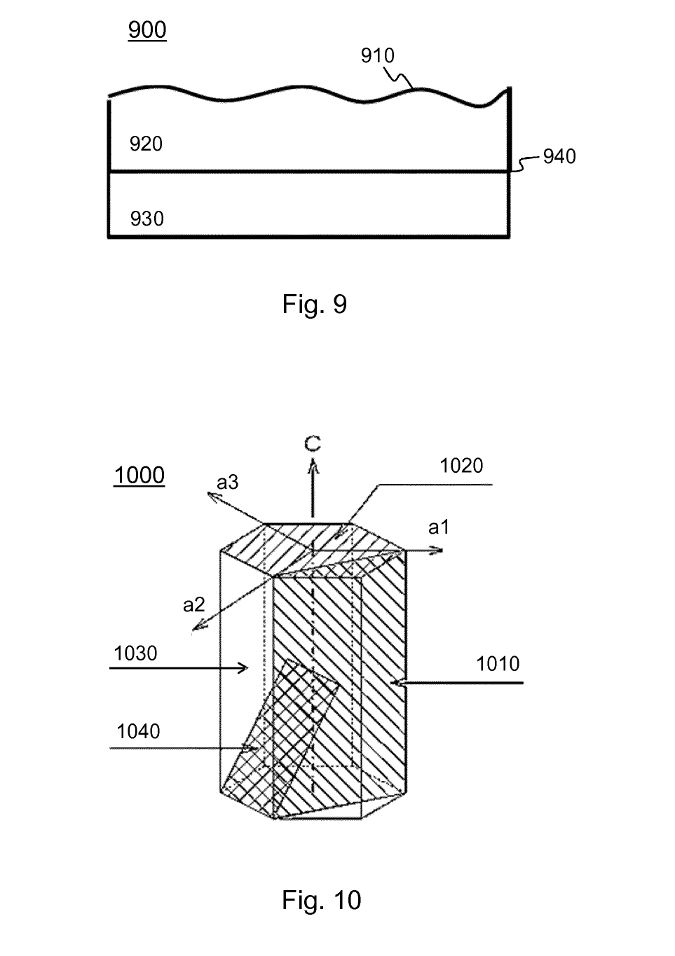

FIG. 9 shows a schematic view of an optical element 900 with a textured structure 920 applied on a sapphire layer 930 as a coating without reducing the strength of the sapphire layer below a threshold, in which various embodiments of the invention may be applied.

In an embodiment, sharp angles are avoided in the coating textured structure 920 due to they are potential areas of stress concentration and sources of damage to the rest of the sapphire screen. FIG. 9 shows an example schematic of the design required. A sinusoidal profile 910 with smooth sides, rounded tips and gentle curves between the peaks may be used. There are no corners or sharp angles at the base or top of the peaks. The textured structure 920 is applied as a coating to the sapphire layer 930 to provide the optical element 900.

It is possible that this method could be used as the final step in the polishing process of the sapphire screen surface, although the sapphire would still need to be polished to a reasonably high standard prior to the features being formed.

In an embodiment, a textured surface coating 920 may be applied to the surface of the layer of sapphire 930 using chemical vapor deposition (CVD). Certain physical vapor deposition (PVD) processes could also apply an alumina coating 920, although the product might not be as robust as the chemical vapor deposition (CVD) method.

In an embodiment, a textured layer 920 may be pre-formed and then glued to the sapphire substrate 930. In such case an optically optimized adhesive 940 may be used between the textured surface coating 920 and the layer of sapphire 930. The adhesive 940 is optional and needed only for the glued coating layer embodiment but not for the PVD and CVD embodiments, for example.

In an embodiment, the sapphire crystal may be either cut or grown so that a specific plane within the crystal is parallel to the sheet orientation of the sapphire. Hence sapphire may be referred to as A-plane or C-plane sapphire, for example. Thus for A-plane sapphire the A-plane is parallel to a screen direction of the optical element.

Sapphire single crystal is an anisotropic material. This means that the material has different mechanical properties (strength, hardness, optical properties etc.) depending on the direction of the crystal. In simplest terms, A-plane sapphire is generally the strongest plane whilst C-plane has the best optical properties.

FIG. 10 shows a schematic view of a sapphire crystal structure 1000, known also as a unit cell, having a plurality of crystal planes 1010-1040, in which various embodiments of the invention may be applied.

In the crystal structure of a sapphire, as shown in FIG. 10, the sapphire crystal is a hexagonal system, wherein C-axis forms a central axis being vertical and normal to C-plane 1020. Due to the symmetry of the sapphire crystal structure the A-plane has numerous A-axes in FIG. 10, for example axis a1 to a3 that are to be extended in three directions perpendicular to C-axis. Respectively, A-plane 1010 is shown in FIG. 10. M-plane 1030 is perpendicular to C-plane 1020 and A-plane 1010. R-plane 1040 is oblique at a constant angle to C-axis.

No matter only four planes 1010-1040 is shown, the crystal cell may comprise other planes. Furthermore, due to crystal symmetry, there may be several identical planes for each major plane. For example, the unit cell 1000 may comprise three A-planes 1010, three R-planes 1040, one C-plane 1020 and three M-planes 1030, for example.

The C-axis is typically angled approximately 57.6 degrees with respect to the R-axis. The R-axis is typically angled with respect to the M-axis by approximately 32.4 degrees.

The planes and axes of the sapphire can be analyzed for example with X-ray or electron diffraction and can be determined about the actual sapphire single crystal.

In an embodiment, measurements of the sapphire crystal have revealed that A-plane is generally the strongest plane regarding to mechanical stress. However, the integration of sapphire to an optical element of a portable apparatus may be taken even further by controlling anisotropy (sometimes referred to as minor planes) such that the sapphire is orientated within the optical element of the apparatus for maximum strength and hence reliability.

In an embodiment, the crystal planes and directions in hexagonal systems may be indexed using Miller indices, wherein crystallographically equivalent planes have indices which appear dissimilar. To overcome this Miller-Bravais indexing system may be used, where a fourth index is introduced to the three of the Miller system.

A plane is then specified using four indices (hkil), where h, k, i and l are integers. The third index is always the negative of the sum of the first two and can be determined from the Miller system.

A direction is specified as [uvtw] where u, v, t and w are integers. The values of u, v and t are adjusted so that their sum is zero. The direction index cannot be written down from the equivalent Miller index.

When looking at FIG. 10 and using the Miller-Bravais indices for defining the planes, following mapping could be used:
C-plane 1020 corresponds to {0 0 0 1} of the Miller-Bravais indices;
R-plane 1040 corresponds to {1̅ 0 1 2} of the Miller-Bravais indices;
A-plane 1010 corresponds to {1 1 2̅ 0} of the Miller-Bravais indices; and
M-plane 1030 corresponds to {1 0 1̅ 0} of the Miller-Bravais indices.

Referring to FIG. 4, A-plane of the sapphire cell 410 is shown. The length L in this embodiment is greater than the width W, as can be seen from FIG. 4. The sapphire crystallographic structure is configured so that a main plane of the sapphire cell 410 is set to be parallel to the surface plane of the optical element 420 and two minor planes are set to be parallel to the first and second axes (W and L).

In an embodiment, the optical element 420 of an apparatus has a length L in a direction of a first axis and a width W in a direction of a second axis, wherein the length L is greater than or equal to the width W. The optical element 420 is developed and comprising a sapphire crystallographic structure 410 having a plurality of crystal planes with corresponding normal axes represented as C-axis, A-axis and M-axis, for example. A first crystal plane axis is configured to be perpendicular to the first axis L and the second axis W. A second crystal plane axis is configured to be parallel to the first axis L and a third crystal plane axis is configured to be parallel to the second axis W.

In an embodiment, a sapphire crystallographic structure has a plurality of crystal planes, wherein three major planes maybe be represented by three orthogonal axis, wherein a first crystal plane axis is configured to be perpendicular to the second crystal plane axis and the third crystal plane axis is configured to be perpendicular to the first crystal plane axis and the second crystal plane axis.

The plurality of crystal planes comprise at least:
A-plane with A-axis configured to be a normal axis of the A-plane;
C-plane with C-axis configured to be a normal axis of the C-plane, the C-axis being perpendicular to the A-axis; and
M-plane with M-axis configured to be a normal axis of the M-plane, the M-axis being perpendicular to the A-axis and the C-axis.

In an embodiment, the plurality of crystal planes comprises:
A-plane with A-axis configured to be a normal axis of the A-plane, the A-axis being perpendicular to the C-axis and perpendicular to the M-axis; and
C-plane with C-axis configured to be a normal axis of the C-plane, the C-axis being perpendicular to the A-axis and perpendicular to the M-axis; and
M-plane with M-axis configured to be a normal axis of the M-plane, the M-axis being perpendicular to the A-axis and perpendicular to the C-axis.

In an embodiment, the first crystal plane axis is the A-axis perpendicular to the W-axis and the L-axis, the second crystal plane axis is the M-axis parallel to the L-axis and the third crystal plane axis is the C-axis parallel to the W-axis.

Configuring the sapphire crystal 410 planes so that A-plane is parallel to the surface plane of the optical element 420, such as flat display screen, provides improved strength for the optical element 420. Even further strength for the optical element is achieved by aligning the M-axis of the M-plane parallel to a longer side L of the optical element 420 and the C-axis of the C-plane parallel to a shorter side of the optical element 420.

Furthermore, a textured structure is arranged on the surface of the layer of sapphire for affecting propagation of visible light incident upon the surface of the layer of sapphire. The structure is configured to have a second refractive index value, the second refractive index value being lower than the first refractive index value, and wherein the textured structure is configured to reduce reflection of the visible light incident from the surface of the layer of sapphire.

Various embodiments have been presented. It should be appreciated that in this document, words comprise, include and contain are each used as open-ended expressions with no intended exclusivity.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. An optical element for a mobile apparatus comprising:
a layer of sapphire having a first refractive index value and comprising a surface, wherein the surface is visible to a user; and
a textured structure arranged on the surface of the layer of sapphire for affecting propagation of visible light incident upon the surface of the layer of sapphire, wherein the structure is configured to have a second refractive index value, the second refractive index value being lower than the first refractive index value, and wherein the textured structure is configured to reduce reflection of the visible light incident from the surface of the layer of sapphire.

2. The optical element of claim 1, wherein the textured structure is configured to make the surface of the layer of sapphire uneven.

3. The optical element of claim 1, wherein the textured structure comprises curved shapes.

4. The optical element of claim 1, wherein the textured structure comprises sinusoidal shapes.

5. The optical element of claim 1, to wherein the textured structure has dimensions of order of 100-400 nm.

6. The optical element of claim 1, wherein the textured structure is integral to the layer of sapphire.

7. The optical element of claim 1, wherein the textured structure is arranged as a coating to the layer of sapphire.

8. The optical element of claim 7, wherein the coating is a sapphire coating.

9. The optical element of claim 7, wherein the coating is an alumina coating.

10. The optical element of claim 1, wherein the optical element further comprises at least one of the following:
a display of the mobile apparatus;
a cover part of the mobile apparatus; and
a touch sensitive screen of the mobile apparatus.

11. The optical element of claim 10, the element having a length in a direction of a first axis and a width in a direction of a second axis, wherein the length is greater than or equal to the width, the optical element further comprising:
sapphire crystallographic structure having a plurality of crystal planes, wherein a first crystal plane axis is configured to be perpendicular to the first and the second axis, a second crystal plane axis is configured to be parallel to the first axis and a third crystal plane axis is configured to be parallel to the second axis
wherein the plurality of crystal planes comprising:
A-plane with A-axis configured to be a normal axis of the A-plane;
C-plane with C-axis configured to be a normal axis of the C-plane, the C-axis being perpendicular to the A-axis; and
M-plane with M-axis configured to be a normal axis of the M-plane, the M-axis being perpendicular to the A-axis and the C-axis;
and further wherein the first crystal plane axis is the A-axis, the second crystal plane axis is the M-axis and the third crystal plane axis is the C-axis.

12. (canceled)

13. (canceled)

14. (canceled)

15. The optical element of any of claims 11 to 14, wherein the optical element having a length in a direction of the M-axis and a width in a direction of the C-axis, wherein the length is greater than or equal to the width.

16. (canceled)

17. A method comprising:
providing a layer of sapphire having a first refractive index value and comprising a surface; and
providing a textured structure on the surface of the layer of sapphire for affecting propagation of visible light incident upon the surface of the layer of sapphire, wherein the structure is configured to have a second refractive index value, the second refractive index value being lower than the first refractive index value, and wherein the textured structure is configured to reduce reflection of the visible light incident from the surface of the layer of sapphire.

18. The method of claim 17, further comprising:
providing the textured structure on the surface of the layer of sapphire using at least one of the following techniques:
lasering the surface of the layer of the sapphire;
ion bombardment of the layer of the sapphire;
chemical etching; and
plasma etching.

19. The method of claim 17, further comprising:
applying a textured surface coating to the surface of the layer of sapphire using a chemical vapor deposition (CVD) process.

20. The method of claim 17, further comprising:
applying a textured surface coating to the surface of the layer of sapphire using a physical vapor deposition (PVD) process.

21. The method of claim 17, further comprising:
applying the textured surface coating to the surface of the layer of sapphire using an adhesive.

22. The method of any of claim 19, further comprising:
polishing the surface of the layer of sapphire before applying the textured surface coating to the surface of the layer of sapphire.

23. A mobile apparatus comprising an optical element of claim 1.

24. The mobile apparatus of claim 23, wherein a higher strength axis of a sapphire element is aligned with a higher stress direction of the mobile apparatus.
